(19) United States
(12) Patent Application Publication
(10) Pub. No.: US 2021/0005997 A1
(43) Pub. Date: Jan. 7, 2021

(54) CONNECTOR FOR HIGH-CURRENT TERMINAL

(71) Applicants: DINKLE ENTERPRISE CO., LTD., New Taipei City (TW); DINKLE ELECTRIC MACHINERY (CHINA) CO., LTD., Kunshan (CN)

(72) Inventor: SHANG-TSAI WU, New Taipei City (TW)

(21) Appl. No.: 16/502,949

(22) Filed: Jul. 3, 2019

(51) Int. Cl. H01R 13/11; H01R 13/41; H01R 13/187

(52) U.S. Cl. CPC H01R 13/112; H01R 13/187; H01R 13/113; H01R 13/41

(57) ABSTRACT

A connector (10) for a high-current terminal, includes a contactor (1) having two clamping arms (11) arranged opposite to each other and two conductive connecting plates (12) respectively extended from the two clamping arms (11) and stacked onto each other. In addition, the high-current terminal (100) is inserted between the two clamping arms (11). Accordingly, the current is provided with independent paths for flowing two conductive connecting plates (12), thereby preventing current overload and achieving the improvement of use safety of the connector (10).

### BACKGROUND OF THE INVENTION

### Field of the Invention

The technical field relates to a connector structure, in particular, to a connector for a high-current terminal.

### Description of Related Art

A connector for high-current terminal is available in the market, and it is used for connecting the bus bar of a network energy equipment, unit base station, server, internet network equipment or industrial power distribution equipment to a circuit board.

In a traditional connector for high-current terminal, it includes one end extended with a conductive connecting plate and another end extended with two clamping arms. The two clamping arms are used for clamping onto the high-current terminal. However, when the current of the high-current terminal flows into the two clamping arms, the current of the two clamping arms merge together to flow onto one identical conductive connecting plate, causing the current on the conductive connecting plate to overload and its temperature to increase. Consequently, the use safety of the connector is affected.

In view of above, the inventor seeks to overcome the aforementioned drawbacks associated with the currently existing technology after years of research and development along with the utilization of academic theories, which is also the objective of the development of the present invention.

### SUMMARY OF THE INVENTION

The disclosure is related to a connector for a high-current terminal, and it uses independent paths for current to flow to each conductive connecting plate in order to prevent current overload, thereby achieving the improvement of use safety of the connector.

One of the exemplary embodiments, a connector for a high-current terminal, comprises a contactor having two clamping arms arranged opposite to each other and two conductive connecting plates extended form the two clamping arms and stacked onto each other; wherein the high-current terminal is inserted between the two clamping arms.

According to the above, when a current of the high-current terminal flows into the two clamping arms, each clamping arm is able to guide the current to each conductive connecting plates respectively in order to allow the current to have independent paths to flow to each conductive connecting plate, thereby preventing the problem of current overload caused by the merge of current onto one single conductive connecting plate. Consequently, it is able to achieve the improvement of use safety of the connector.

In addition, according to the above, each clamping arm includes a plurality of slots and a plurality of flexible terminals formed opposite to the plurality of slots. Each flexible terminal includes a plurality of arched protruding points bent inward and abutted against the high-current terminal in order to allow each clamping arm to have greater number of effective electrical contact points with the high-current terminal.

### BRIEF DESCRIPTION OF DRAWING

FIG. 1 is an exploded perspective view of the connector of the present invention;

FIG. 2 is a perspective view of the contactor of the present invention;

FIG. 3 is a top view of the contactor of the present invention;

FIG. 4 is a perspective assembly view of the connector of the present invention;

FIG. 5 is an illustration showing a state of use of the connector of the present invention;

FIG. 6 is an exploded perspective view of the connector according to another exemplary embodiment of the present invention; and

FIG. 7 is an illustration showing a state of use of the connector according to another exemplary embodiment of the present invention.

### DETAILED DESCRIPTION OF THE INVENTION

The following provides a detailed technical content of the present invention along with the accompanied drawings. However, the accompanied drawings are provided for reference and illustrative purpose only such that they shall not be used to limit the scope of the present invention.

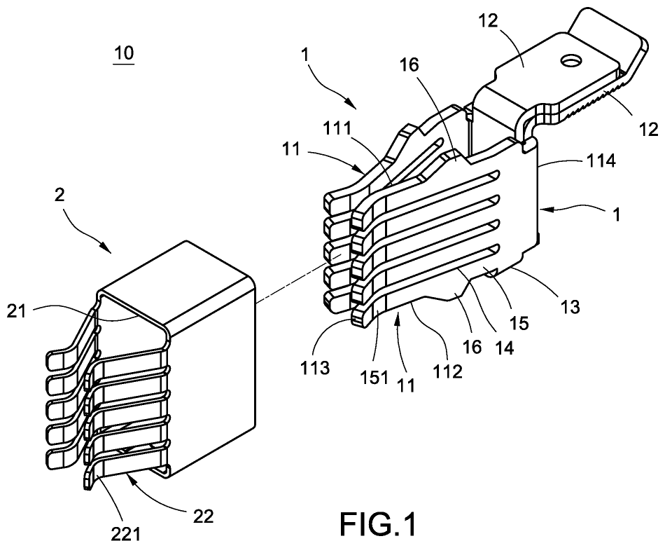

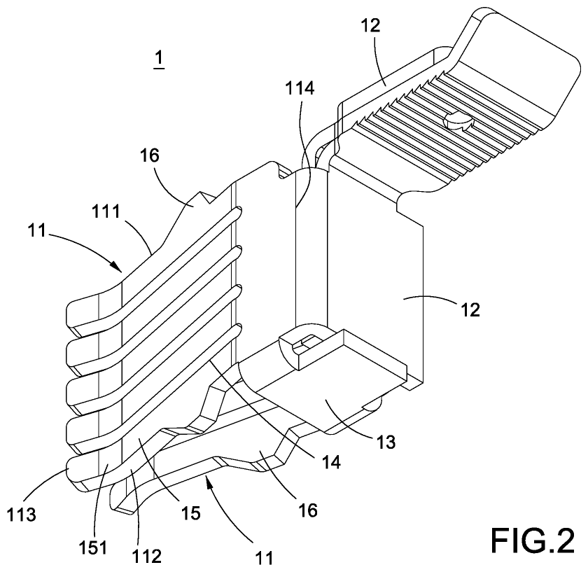

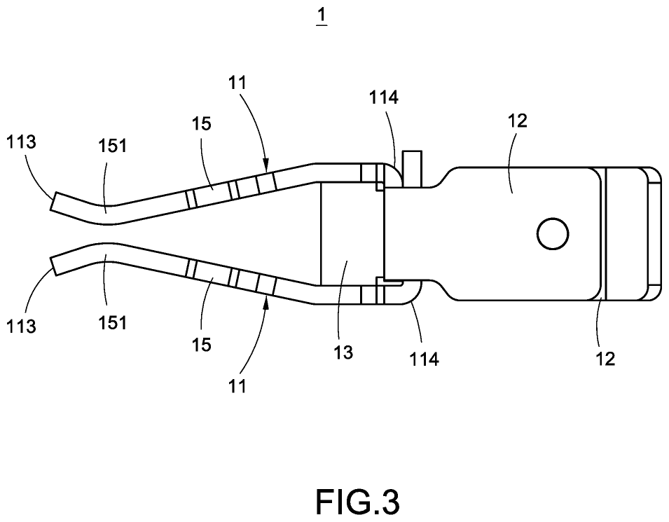

Please refer to FIG. 1 to FIG. 5. The present invention provides a connector for a high-current terminal, and such connector 10 mainly comprises a contactor 1 and a housing 2.

As shown in FIG. 1 to FIG. 5, the contactor 1 is made of a metal material. The contactor 1 includes two clamping arms 11 arranged opposite to each other and two conductive connecting plates 12 respectively extended from the two clamping arms 11 and stacked onto each other. In addition, the two conductive connecting plates 12 are secured onto each other via a method of riveting, fastening or stamping.

The following provides further detailed description. Each one of the clamping arms 11 includes a top end 111, a bottom end 112, a front end 113 and a rear end 114. Each one the conductive clamping plates 12 is respectively formed to extend from one of the rear ends 114 and to bend toward a direction facing another one of the rear ends 114. Furthermore, each conductive connecting plate 12 is an L-shaped plate bent toward a direction away from the two clamping arms 11.

In addition, the two bottom ends 112 include a joining plate 13 integrally extended from and bridged between the two clamping arms 11, thereby the two clamping arms 11 and the two conductive connecting plates 12 are integrally formed of and bent into shape with one identical metal.

Furthermore, each clamping arm 11 includes a plurality of slots 14 formed to extend from the front end 113 toward the rear end 114 and a plurality of flexible terminals 15 formed opposite to the plurality of slots 14. Each flexible terminal 15 is bent inward to abut against a plurality of arched protruding points 151 of the high-current terminal 100 in order to allow each clamping arm 11 to form a greater number of effective electrical contact points with the high-current terminal 100, thereby achieving a relatively more stable connection between the connector 10 and the high-current terminal 100.

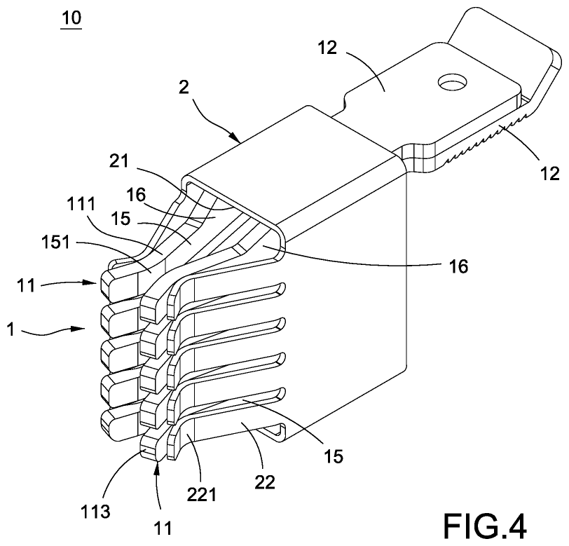

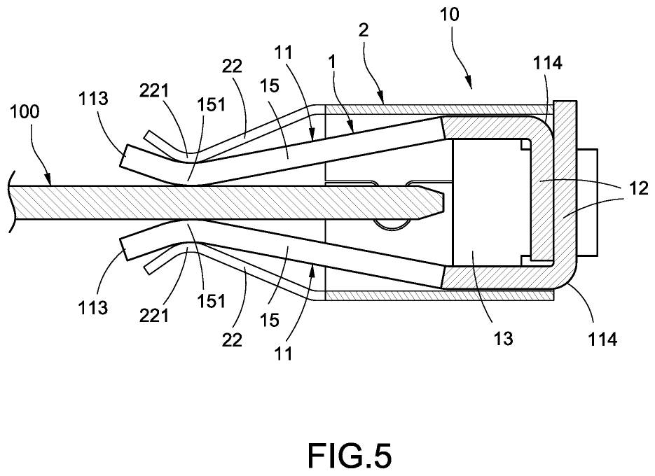

As shown in FIG. 1, FIG. 4 to FIG. 5, the housing 2 is made of a rigid material with flexibility, such as metal or plastic etc. The housing 2 is mounted onto the contactor 1, and the housing 2 includes an opening 21 with the two clamping arms 11 exposed therefrom. The high-current terminal 100 is inserted between the two clamping arms 11 via the opening 21.

The following further detailed description. The top end 111 and bottom end 112 of each clamping arm 11 include a retaining piece 16 extended therefrom respectively. One end of the housing 2 is retained by each one of the retaining pieces 16 and another end thereof is retained by the two conductive connecting plates 12. In other words, the housing 2 is clamped between each one of the retaining pieces 16 and the two conductive connecting pieces 12, such that the housing 2 can be stably and firmly mounted onto the contactor 1.

Moreover, the housing 12 includes a plurality of flexible pressing legs 22 extended therefrom and arranged corresponding to the plurality of flexible terminals 15. Each one of the flexible pressing legs 22 includes an inward bending protrusions 221 bent inward. Each one of the inward bending protrusions 221 abuts against each one of the arched protruding points 151, allowing each inward bending protrusion 221 to exert a pressure onto each arched protruding points 151, such that each flexible terminal 15 is able to stably clamp the high-current terminal 100. Consequently, it is able to increase the connection stability between the connector 10 and the high-current terminal 100.

As shown in FIG. 1 to FIG. 2 and FIG. 5, according to a state of use of the connector 10 of the present invention, when it uses the high-current terminal 100 to allow the current to flow into the two clamping arms 11, each clamping arm 11 is able to guide the current to each conductive connecting plate 12 in order to allow the current to have independent path for flowing to each conductive connecting plate 12, thereby preventing the current from merging to flow to one identical conductive connecting, causing the problem of current overload. As a result, it is able to achieve the effect of improving the use safety of the connector 10.

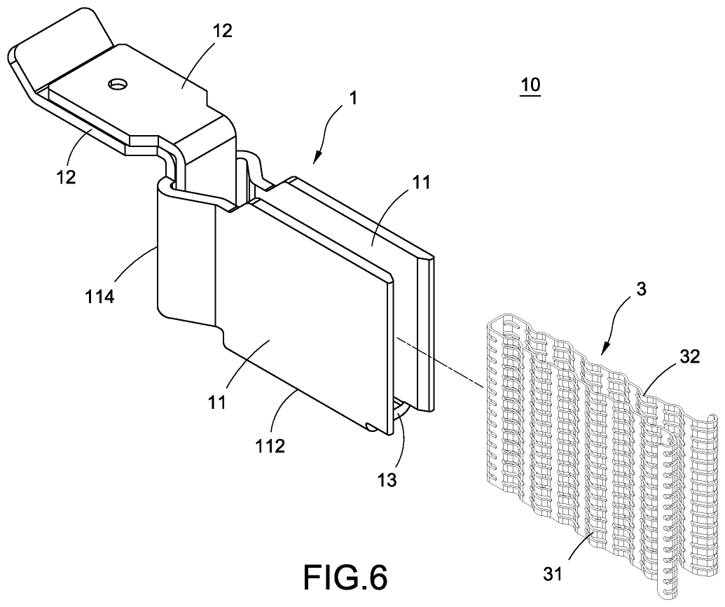

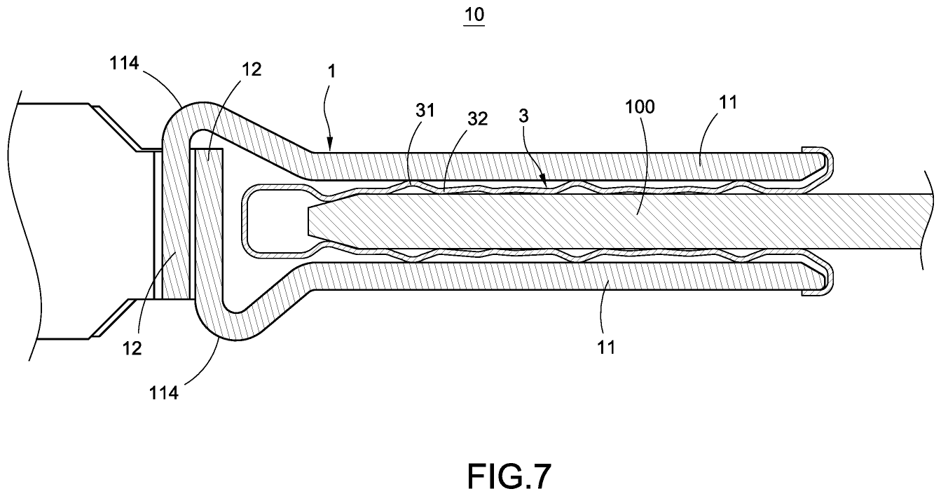

Please refer to FIG. 6 to FIG. 7, showing another exemplary embodiment of the connector 10 of the present invention. The different between the exemplary embodiment shown in FIG. 6 to FIG. 7 and the exemplary embodiment shown in FIG. 1 to FIG. 6 relies in that the connector 10 of the present invention further comprises a conductive separation plate 3, and element of housing 2 is omitted.

The following provides further detailed description. The conductive separation plate 2 is made of a metal material. The conductive separation plate 3 is arranged between the two clamping arms 11 and the high-current terminal 100. The conductive separation plate 3 includes a plurality of outer protrusions 31 abutted against the two clamping arms 11 and a plurality of inner protrusions 31 abutted against the high-current terminal 100. Accordingly, the two clamping arms 11 and the high-current terminal 100 are able to use the plurality of outer protrusions 31 and the inner protrusions 32 to increase the electrical contacts and to adjust the current. In addition, the conductive separation plate 3 can be used to fill in the gap between the two clamping arms 11 and the high-current terminal 100, thereby allowing the connector 10 to have an excellent conductivity, current regulating capability and structural stability.

In view of the above, a connector for a high-current terminal of the present invention has not been disclosed by the same type of products and has not been used in the public. The present invention is novel and of inventive step, which satisfies the patentability requirements. The above describes the preferable and feasible exemplary embodiments of the present invention for illustrative purposes only, which shall not be treated as limitations of the scope of the present invention. Any equivalent changes and modifications made in accordance with the scope of the claims of the present invention shall be considered to be within the scope of the claim of the present invention.

1. A connector for a high-current terminal, comprising:
a contactor (1) having two clamping arms (11) arranged opposite to each other and two conductive connecting plates (12) respectively extended from the two clamping arms (11) and stacked onto each other; wherein the high-current terminal (100) is inserted between the two clamping arms (11);
wherein each of the two clamping arms (11) includes a front end (113) and a rear end (114); the front end (113) includes a plurality of flexible terminals (15);
wherein each of the two clamping arms (11) includes a bottom end (112); the bottom end (112) is covered with a joining plate (13) interconnecting the two clamping arms (11); and
wherein the joining plate (13) extends from the rear end (114) to the front end (113).

2. The connector for a high-current terminal according to claim 1, wherein each one of the conductive connecting plates (12) is formed to extend from one of the rear ends (114) and to bend toward a direction facing another one of the rear ends (114).

3. The connector for a high-current terminal according to claim 2, wherein each of the conductive connecting plates (12) is an L-shaped plate bent toward a direction away from the two clamping arms (11).

4. (canceled)

5. The connector for a high-current terminal according to claim 1, wherein the two conductive connecting plates (12) are secured onto each other via a method of riveting, fastening or stamping.

6. The connector for a high-current terminal according to claim 1, further comprising a housing (2); the housing (2) is mounted onto the contactor (1), and the housing (2) includes an opening (21) with the two clamping arms (11) exposed therefrom.

7. The connector for a high-current terminal according to claim 6, wherein each one the two clamping arms (11) includes a plurality of slots (14) formed to extend from the front end (113) toward the rear end (114) and the plurality of flexible terminals (15) formed opposite from the plurality of slots (14).

8. The connector for a high-current terminal according to claim 7, wherein each of the flexible terminals (15) is bent inward to form a plurality of arched protruding points (151) abutting against the high-current terminal (100); the housing (2) includes a plurality of flexible pressing legs (22) extended therefrom and arranged corresponding to the plurality of flexible terminals (15); each one of the flexible pressing legs (22) includes an inward bending protrusions (221) bent inward; each one of the inward bending protrusions (221) abuts against a corresponding one of the arched protruding points (151).

9. The connector for a high-current terminal according to claim 6, wherein each of the clamping arms (11) further includes a top end (111); each one of the top ends (111) and each one of the bottom ends (112) include a retaining piece (16) extended therefrom respectively; one end of the housing (2) is retained by each one of the retaining pieces (16) and another end thereof is retained by the two conductive connecting plates (12).

10. The connector for a high-current terminal according to claim 1, further comprising a conductive separation plate (3); the conductive separation plate (3) is arranged between the two clamping arms (11) and the high-current terminal (100); the conductive separation plate (3) includes a plurality of outer protrusions (31) abutted against the two clamping arms (11) and a plurality of inner protrusions (32) abutted against the high-current terminal (100).
